(19) United States
(12) Patent Application Publication
(10) Pub. No.: US 2024/0351362 A1
(43) Pub. Date: Oct. 24, 2024

(54) MULTI-TOOL MARKING DEVICE

(71) Applicants: David Shulman, Los Angeles, CA (US); Ryan Kung, Laguna Niguel, CA (US)

(72) Inventors: David Shulman, Los Angeles, CA (US); Ryan Kung, Laguna Niguel, CA (US)

(21) Appl. No.: 18/641,737

(22) Filed: Apr. 22, 2024

Related U.S. Application Data
(60) Provisional application No. 63/497,347, filed on Apr. 20, 2023.

(51) Int. Cl. B43K 8/00; A62B 3/00; B43K 19/02; B43K 19/04; B43K 23/02; B43K 23/12; B43K 25/02; B43K 29/02

(52) U.S. Cl. CPC B43K 8/003; A62B 3/00; B43K 19/02; B43K 19/04; B43K 23/12; B43K 25/024; B43K 29/02; B43K 23/02

(57) ABSTRACT

A handheld device which is capable of writing on a variety of surfaces using ink or graphite, as well as a tool for scribing, scratching, and scoring numerous materials such as metal, wood, or plastic. The handheld device may be used for piercing holes in softer materials such as leather or paper, for breaking harder materials such as ice or glass, for self-defense against a human or animal attacker, to pry open or wedge closely positioned objects, and to clean or scrape material off of another surface. The handheld device resembles a common wooden pencil, making its purpose discreet to an outside observer. The handheld device includes a cap that covers the writing implement side of the device, which both protects the writing implement and also contributes to the overall appearance as a common wooden pencil.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### Field of the Invention

The invention relates in general to hardware and tools and more specifically, to marking instruments for self-defense, writing, scribing, scoring, etching, engraving and the like.

### Description of Related Art

Several similar competing products offer similar simplified functions, but fail to include features expanding the uses and simplicity of the implements. The present invention improves upon the durability of the implement while expanding on the multitude of uses by incorporating additional features that will be explained. The present invention also reduces the number of implements a person would need to carry to perform the additional functions that competing products do not cover.

### SUMMARY OF THE INVENTION

A handheld multitool device which is capable of writing on a variety of surfaces using ink or graphite, as well as a tool for scribing, scratching, and scoring numerous materials such as metal, wood, or plastic, and for piercing holes in softer materials such as leather or paper, and for breaking harder materials such as ice or glass, and for self-defense against a human or animal attacker, and to pry open or wedge closely positioned objects, and to clean or scrape material off of another surface. It intentionally appears nearly identical to a common wooden pencil, making its purpose discreet to an outside observer.

One end of the device contains a threaded bore which can accept multiple different inserts, including but not limited to: graphite writing tips, tungsten carbide points, touch screen writing styluses, utility knives, abrasive files, lock picks, flint strikers, eating utensils, bottle openers, and other such small tools. The other end of the device contains an ink cartridge such as found in a pen.

The device additionally has a cap that covers the writing implement side of the device which includes the ink cartridge. The cap both protects the ink cartridge and also contributes to the product's overall appearance as a common wooden pencil. This cap contains a rubber eraser which serves a dual purpose. (1) When using the tungsten carbide pointed tip for puncturing, this rubber eraser provides a cushion for the user's hand to reduce the amount of pressure they feel thereby increasing comfort. (2) When using the graphite writing tip, the eraser functions as a normal eraser to remove the pencil markings from the writing surface. The eraser may be secured in place by way of adhesive, or a clamped retaining feature designed into the cap.

Furthermore, the cap contains an embedded permanent magnet. Once the cap is removed to reveal the ink writing tip, the cap can then be placed over any of the tungsten carbide, steel or ferritic attachments on the other end, which will retain the cap in place due to the magnetic force. This provides a convenient way to store the cap, while also protecting the user from the sharp end of the product while they are using the ink cartridge to write. The magnet may be secured in place by way of a press fit or adhesive.

The device is slimmer than similar “tactical pen” products, making it easier to carry and store. The device doesn't roll away on a flat surface due to flats on the body of the device. The device possesses a sharper or narrower tip having a more acute angle than similar products, making it far more effective for scoring, piercing holes, prying, and scraping. The device appears nearly identical to a wooden writing pencil (#2 pencil), making it more discreet than similar products. The device is modular and can hold a wide variety of tools, making it more versatile. The device rubber eraser provides safety and ergonomic comfort to the user. The device magnet allows the cap to be easily stored when not in use. The device provides tool-specific uses: builders, machinists, artists, DIY enthusiasts, home renovators. The device provides self-defense uses: any member of the public who carries tools for their self-defense. The device is a modular handheld tool consisting of a hexagonal body, a capped writing implement, and an attachment point for multiple different tools, including but not limited to a hardened metal tip. The device is a handheld tool designed to appear like a wooden writing pencil, commonly known as the “#2 pencil.” These specific appearances include a hexagonal cross section, a removable cap, threaded or press-fit, which appears like the eraser and metallic crimp on a #2 pencil, a tip that appears like a sharpened pencil point, and very similar proportions and overall size to a #2 pencil.

The device is a writing instrument designed to appear like a wooden writing pencil, with a variety of other uses. Despite its appearance as a wooden #2 pencil, its composition is far more robust and durable than wood. The body, nib holder, and cap are made from metal alloys, while the different tips are made from a variety of materials, including graphite, hardened metal alloys such as tungsten carbide, steel, etc.

The device consists of a hexagonal metal rod, informally called the “body,” which at one end narrows into a round cross section known as a conical frustum. The body has a cylindrical cavity at this end into which contains a machine thread. A separate component informally called the “tip” is threaded into this portion of the body. The tip can take various forms, including but not limited to: graphite writing tips, tungsten carbide points, touch screen writing styluses, utility knives, abrasive files, lock picks, flint strikers, eating utensils, bottle openers, and other such small tools. Examples include a graphite/plastic composite injection molded pencil tip, a sharpened “point” made of a steel/tungsten carbide composite which is press-fit into an aluminum “tool adapter”, and a wide-angle point made of a higher concentration of tungsten carbide which can be used to break glass. The points of tips may be secured into their tool adapters by means other than a press-fit.

Tungsten carbide is a metal uniquely sought for its hardness properties and is used in the tips of the pointed tools for the multi-tool marking device. The other end of the device contains a cylindrical, partially-threaded cavity into which a ball point ink cartridge, currently of form factor D1, is inserted to serve as a writing implement. The ink cartridge may be unpressurized or pressurized and is retained into the cylindrical hole in the body by way of a press-fit retention device, or bushing, that uses friction to hold the ink cartridge in place and align its center axis with that of the body. The ink cartridge is additionally secured through a nib holder which attaches to the body through machine threads which connect to the partially threaded cavity on the body. The nib holder includes an axial through-hole to align the ink cartridge center axis with that of the body and, in conjunction with a linear spring, additionally prevents axial and linear movement of the ink cartridge. The nib holder also possesses a second set of machine threads which retain a “cap.” Both sets of threads have flat sections 118 which allow the use of a wrench to unscrew the nib holder from either the body or the cap. The aforementioned threaded cap protects the ink cartridge from contact and impact damage, elemental exposure, and from unintentionally marking undesired surfaces. In addition, it contributes to the appearance of the entire device as a wooden writing pencil, by being similar or identical in size and also containing a rubber eraser as commonly found on such pencils. The rubber eraser serves several functions such as providing a cushion for the user's hand to reduce the amount of pressure they feel when using the tool for self-defense, and providing a traditional eraser to remove pencil markings when the device is being used as a graphite pencil.

Furthermore, the cap contains an embedded permanent magnet. Once the cap is removed to reveal the ink writing tip, the cap can then be placed over any of the tungsten carbide or steel attachments on the other end, which will retain the cap in place due to the magnetic force. This provides a convenient way to store the cap, while also protecting the user from the sharp end of the product while they are using the ink cartridge to write. The device is sealed to the elements by way of two O-rings which reside at the ends of the threaded sections on the nib holder and contact the body and cap respectively. The device may employ a clip consisting of a thin piece of stamped and formed metal or injection molded plastic similar to a pen cap clip that allows the user to attach this device to their pocket or any other relatively thin piece of material. The clip may be retained by way of clamping between the nib holder and the body, or could rest on the exterior of the body using frictional force. The metal components, specifically the tool adapters, body, nib holder, cap, and clip may be composed of Aluminum, Steel, Titanium, Brass, or variations of these alloys. They may be painted or coated in a variety of colors using any of the available finishing processes, including but not limited to anodization and powder coating.

The nib holder may continue to use threads, though one or both of the threads change to a different form of mechanical fixturing, e.g. press-fit, magnetic lock.

The metal components are currently produced through subtractive manufacturing, i.e. machining, milling, turning (lathing). These may continue to be the processes of record, or they may transition to additive manufacturing processes, i.e. metal laser sintering.

An additional process may be employed to diamond-coat the tungsten carbide tips, further enhancing the hardness without incurring significantly higher material costs. This process will likely be chemical vapor deposition (CVD) but is not limited to that specific process.

A tip protector provides protection at the pointed tool tip of the device wherein unintentional use of any of its listed purposes is avoided. The tip protector may be made of leather, plastic polymer, carbon fiber, or any other commonly used engineering material.

A first implementation of the invention is a handheld device which is capable of marking on a variety of surfaces using ink or graphite, as well as a tool for scribing, scratching, and scoring numerous materials such as metal, wood, or plastic. The device can be used for piercing holes in softer materials such as leather or paper, breaking harder materials such as ice or glass, self-defense against a human or animal attacker, prying open or wedge closely positioned objects, and to clean or scrape material from another surface.

The implement appears as a common wooden pencil, making its purpose discreet to an outside observer. It additionally has a cap that covers the writing implement side of the device, which both protects the writing implement and also contributes to the product's overall appearance as a common wooden pencil.

Advantages over other products include being slimmer than nearly all similar products, making it easier to carry and store. It doesn't roll away on a flat surface due to flats on the body of the device. It possesses a sharper tip than similar products, making it far more effective for scoring, piercing holes, prying, and scraping. It appears similar to a wooden pencil, making it more discreet than similar products.

This invention is applicable to builders, machinists, artists, DIY enthusiasts, home renovators, and others, as a writing instrument, specifically a pen, as well as a sharpened tungsten carbide tool serving functions such as a scriber, awl, glass breaker, or anything a sharp, pointed object is need for.

This invention can be used in self-defense or other emergency situations.

One aspect of the present invention is directed to a multi-tool marking device. The multi-tool marking device includes a hexagonal body having a tool end and a writing end. The multi-tool marking device includes a threaded bore disposed on the tool end, a first pointed tool engageable with the threaded bore and an elongated opening disposed on the writing end, the elongated opening having female threads disposed along an end portion of the elongated opening. The multi-tool marking device includes a nib holder having first male threads engageable with the elongated opening female threads, an adapter opening extending through the nib holder and second male threads opposite the first male threads and a removable ink cartridge disposed in the elongated opening and through the nib holder, the removable ink cartridge having a writing tip disposed on one end and a second ink cartridge end opposite the writing tip. The multi-tool marking device includes a bushing engageable with the second ink cartridge end, the bushing disposable adjacent an internal end of the elongated opening, the bushing for centering the second ink cartridge end. The multi-tool marking device includes a spring disposable in the elongated opening between the bushing and the nib holder wherein the removable ink cartridge is disposed inside the spring for maintaining the position of the ink cartridge in the elongated opening. The multi-tool marking device includes a removable cap engageable with the second male threads on the nib holder. The removable cap is for covering the ink cartridge. In an alternate embodiment, a magnet may be disposed in the removable cap and the eraser may have a metal insert wherein the eraser is attachable to the removable cap by magnetic force between the magnet and the metal insert. The first pointed tool may include a graphite tip and is engageable with the threaded bore. The first pointed tool may include a tool adapter, which may be composed of aluminum alloy, having male adapter threads engageable with the threaded bore and internal female threads for attachment of a tungsten carbide tip. The tungsten carbide tip may be a scribing tip or may be for breaking glass. The first pointed tool may include a hard metal tip and may be replaceable with a second pointed tool. The hard metal tip may be tungsten carbide. The second pointed tool may be a graphite writing tip. The second pointed tool may be for breaking glass. The first pointed tool may be replaceable with a second pointed tool, the first and second pointed tools selected from a group consisting of a screen writing stylus, a utility knife, an abrasive file, a lock pick, a flint striker, an eating utensil, and a bottle opener. The hexagonal body may be a metal alloy selected from a group consisting of aluminum, steel, titanium, and brass. The cap may be secured to the hexagonal body by a threaded connection. The permanent magnet may be secured to the cap by a press-fit connection or adhesive. The multi-tool marking device may include a clip for attaching the device to a pocket or thin piece of material. The multi-tool marking device may include a clip for attaching the multi-tool marking device to a pocket or other thin piece of material. The multi-tool marking device may appear substantially identical to a common wooden pencil to make it discreet to an outside observer.

### BRIEF DESCRIPTION OF DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a perspective view of the multi-tool marking device according to the present invention;

FIG. 2 is a side elevational view of the multi-tool marking device shown in FIG. 1;

FIG. 3 is a side elevational view of the hexagonal body;

FIG. 4 is a side elevational view of the multi-tool marking device without the cap portion;

FIG. 5 is a cross-sectional side view of the multi-tool marking device shown in FIG. 1;

FIG. 6 is an exploded view of the multi-tool marking device shown in FIG. 1;

FIG. 7 is a side elevational view of a pointed tool on one end of the view of the multi-tool marking device shown in FIG. 1;

FIG. 8 is a cross sectional view of the pointed tool shown in FIG. 7;

FIG. 9 is a side elevational view of a pointed tool having a graphite tip;

FIG. 10 is a side elevational view of a pointed tool for breaking glass;

FIG. 11 is a side elevational view of the nib holder;

FIG. 12 is a top plan view of a of the nib holder shown in FIG. 11;

FIG. 13 is a cross sectional view of the nib holder shown in FIG. 12;

FIG. 14 is a side elevational view of the cap portion of the multi-tool marking device;

FIG. 15 is a cross-sectional view of the cap portion shown in FIG. 14;

FIG. 16 is a cross sectional side view of the writing end of the multi-tool marking device;

FIG. 17 is a cross sectional side view of a midportion of the multi-tool marking device;

FIG. 18 is a cross sectional side view of the pointed tool end of the multi-tool marking device;

FIG. 19 is a perspective view of a multi-tool marking device having a clip;

FIG. 20 is a side elevational view of the clip shown in FIG. 19; and

FIG. 21 is a perspective view of the clip shown in FIG. 19.

### DETAILED DESCRIPTION OF THE INVENTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

The terms #2 pencil and wooden pencil are used synonymously and interchangeably, referring to the likeness of the common graphite filled wooden pencil.

The terms marking and writing are used interchangeably and refer to any form of marking on any medium.

As this invention is susceptible to embodiments of many different forms, it is intended that the present disclosure be considered as an example of the principles of the invention and not intended to limit the invention to the specific embodiments shown and described.

The device consists of a hexagonal metal tube or implement body, narrowing to a frusto-conical tip at one end. At the frusto-conical tip end, a tip is secured through a press-fit, adhesive or fastener, into a cylindrical cavity disposed in the body. The tip may also be fastened to a tool adapter, the tool adapter secured to the cylindrical cavity in the body. The tip consists of a metal alloy, typically tungsten carbide, a metal uniquely sought for its hardness. The frusto-conical tip end of the tool provides for a multitude of uses as previously described.

The opposite end of the device incorporates a cylindrical, partially-threaded cavity into which a ball point ink cartridge, preferably of form factor D1, is inserted to serve as a writing implement. The cartridge is retained in the cylindrical cavity in the body by way of a press-fit retention device or bushing, which uses friction to hold the back end of the ink cartridge in place and align the center axis of the ink cartridge with the center axis of the body.

The ink cartridge tip is secured through a nib holder, attaching to the body through a set of machine threads screwed into the partially threaded cavity in the body. This nib holder possesses an axial through-hole to align the pen tip's center axis with that of the body and, in conjunction with a linear spring, prevents axial and linear movement of the pen tip.

The nib holder includes a second set of machine threads for retaining a protective cap. Both sets of threads have flat sections 118 which allow the use of a wrench to unscrew the nib holder from either the body or the cap. The protective cap protects the pen tip from contact and impact damage, elemental exposure, and from unintentionally marking undesired surfaces. In addition, the protective cap contributes to the appearance of the entire device as a wooden writing implement, being similar in size and shape to the rubber eraser and metal crimp commonly found on wooden pencils.

The device is sealed to the elements by way of two O-rings which reside at the ends of the threaded sections on the nib holder and contact the body and cap respectively.

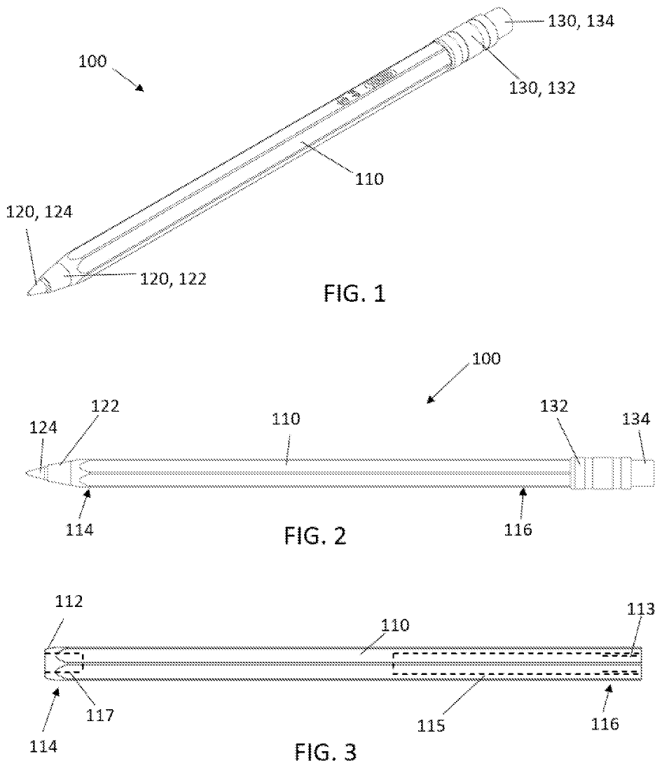

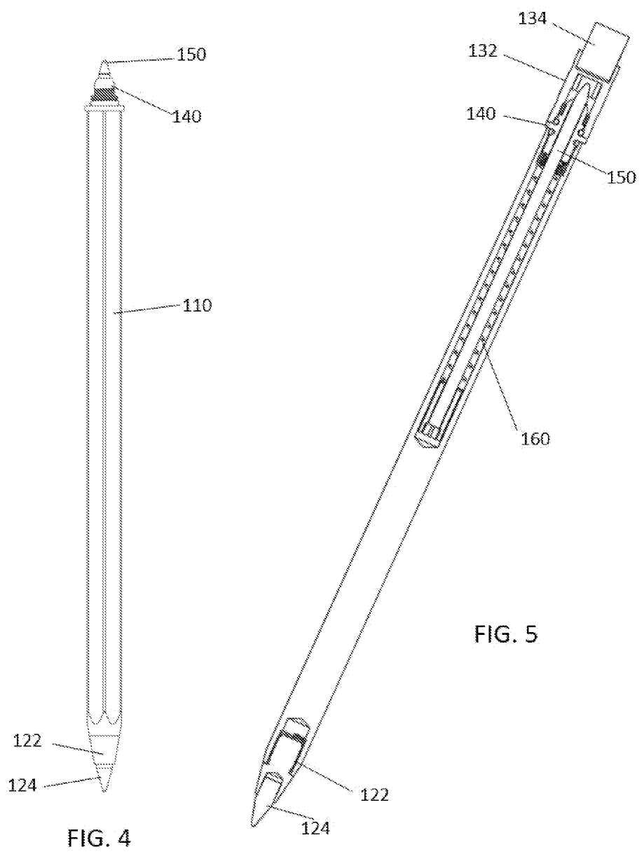

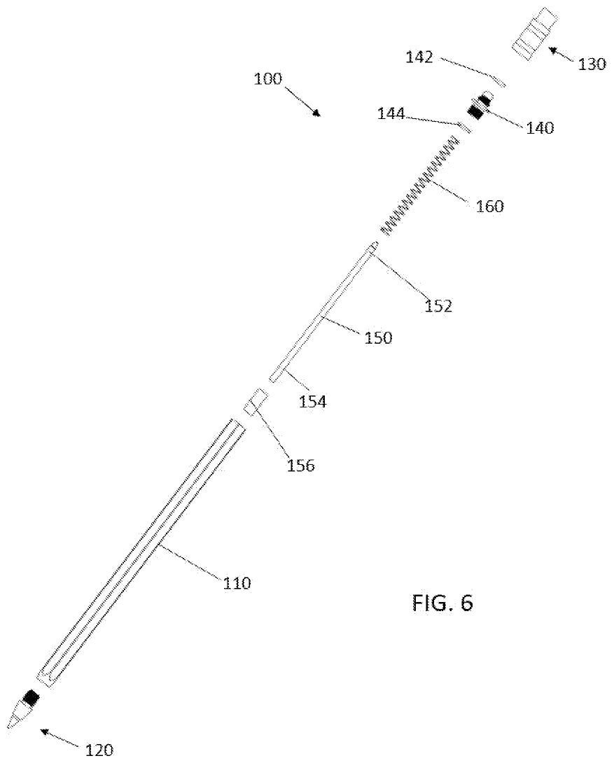

A multi-tool marking device 100 shown in FIGS. 1 and 2 includes a hexagonal body 110 having a tool end 114 and a writing end 116. The multi-tool marking device 100 includes tool portion 120, tool adapter 122 which may be composed of aluminum alloy, and a pointed and hardened tool 124 disposed on the tool end 114. The tool adapter may alternately be made of a material other than aluminum alloy. The multi-tool marking device 100 includes tool portion 120 a cap portion 130 having a removable cap 132 and an eraser 134 on the writing end. The hexagonal body is shown in FIG. 3 and shows a taper 112 on the tool end 114. FIG. 4 shows the multi-tool marking device 100 without the cap portion to reveal the ink cartridge 150 and the nib holder 140. FIG. 5 showing a cutaway view of the multi-tool marking device and FIG. 6 showing an exploded view of the multi-tool marking device 100 includes the nib holder 140 having first male threads 141 engageable with elongated opening female threads 113 in an elongated opening 115 and an adapter opening 148 extending through the nib holder 140. Second male threads 143 opposite the first male threads and a removable ink cartridge disposed in the elongated opening and through the nib holder, the removable ink cartridge having a writing tip disposed on one end and a second ink cartridge end opposite the writing tip. The multi-tool marking device 100 includes a threaded bore 117 disposed on the tool end, a first pointed tool 120 with a set of threads 123 engageable with the threaded bore and an elongated opening disposed on the second end, the elongated opening having female threads disposed along an end portion of the elongated opening. The removable ink cartridge 150 includes a writing tip 152 disposed on one end and a second ink cartridge end 154 opposite the writing tip 152. The multi-tool marking device 100 includes a bushing 156 engageable with the second ink cartridge end, the bushing disposable adjacent an internal end of the elongated opening, the bushing for centering the second ink cartridge end. The multi-tool marking device includes a spring 160 disposed in the elongated opening between the bushing 156 and the nib holder 140 wherein the removable ink cartridge 150 is disposed inside the spring for maintaining the position of the ink cartridge in the elongated opening 115. O-rings 142, 144 are disposed adjacent the threads 141, 143 so the cap portion 130 seals the ink cartridge within the elongated opening 115. The device is therefore sealed to the elements by way of the two O-rings 142, 144 which reside at the ends of the threaded sections on the nib holder and contact the body and cap respectively.

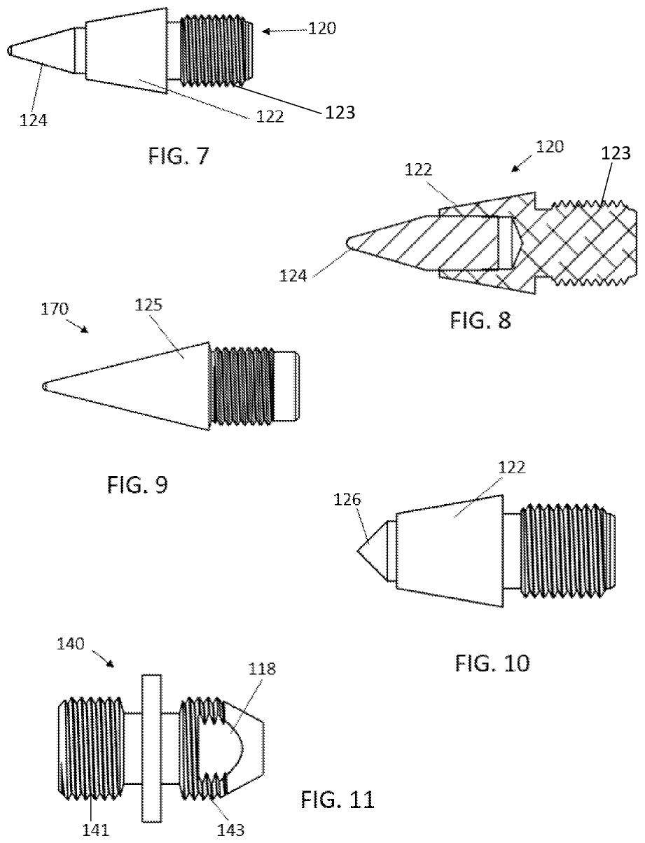

A pointed tool as shown in FIG. 7 and in a cross-sectional view of FIG. 8 may be sharp tip 120 usable as a self-defense tool and includes a tool adapter 122 having male adapter threads 123 engageable with the threaded bore 117 and an internal cavity for attachment of a pointed and hardened tool 124 which is preferably a tungsten carbide tip. The tungsten carbide tip is used as a scribing tip or a self-defense tool. In an alternate embodiment shown in FIG. 10, the tool adapter 122 is fitted with a tungsten carbide tip 126 having a larger tip angle for breaking glass in an emergency situation.

Another example of a pointed tool shown in FIG. 9 is a graphite tip 170 having graphite tip threads 125 engageable with the threaded bore 117. The graphite tip 170 allows a user to write on an object with the writing being erasable similar to a regular pencil.

The first pointed tool may include a hard metal tip and may be replaceable with a second pointed tool. The hard metal tip may be tungsten carbide. The second pointed tool may be a graphite writing tip. The second pointed tool may be for breaking glass. The first pointed tool may be replaceable with a second pointed tool, the first and second pointed tools selected from a group consisting of a screen writing stylus, a utility knife, an abrasive file, a lock pick, a flint striker, an eating utensil, and a bottle opener. The hexagonal body may be a metal alloy selected from a group consisting of aluminum, steel, titanium, and brass. The cap may be secured to the hexagonal body by a threaded connection. The permanent magnet may be secured to the cap by a press-fit connection or adhesive.

The multi-tool marking device 100 includes a nib holder 140 shown in a side elevational view in FIG. 11 and includes threads 141 engageable in the female threads 113 of the writing end 116 of the hexagonal body 110 and cap threads 143 for engaging the female threads 136 of the cap portion 130. A flat portion 118 provides a contact surface which allows for removal of the nib holder 140 for access to the ink cartridge 150 using a wrench. The nib holder 140 may also be tightened onto the hexagonal body 110 after removal of the nib holder 140 for replacement of the ink cartridge 150.

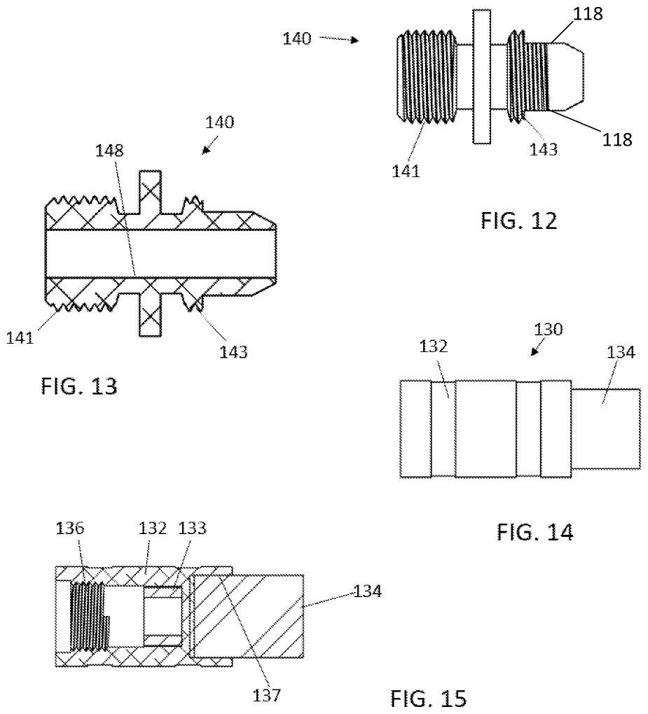

The nib holder 140 is shown in a top plan view of FIG. 12 and a cross-section view of FIG. 13. The nib holder 140 includes first male threads 141 engageable with the elongated opening female threads 113, an adapter opening 148 extending through the nib holder 140 and second male threads 143 opposite the first male threads 141 and engageable with the female threads 136 of the cap portion 130. The removable ink cartridge 150 is disposed in the elongated opening 115 and extends through the nib holder opening 148.

As shown in FIGS. 14 and 15, the multi-tool marking device 100 includes a removable cap 130 engageable with the second male threads 143 on the nib holder 140, the removable cap 130 for covering the ink cartridge tip 152. A magnet 133 is disposed in the removable cap 130 for attachment of the eraser 134.

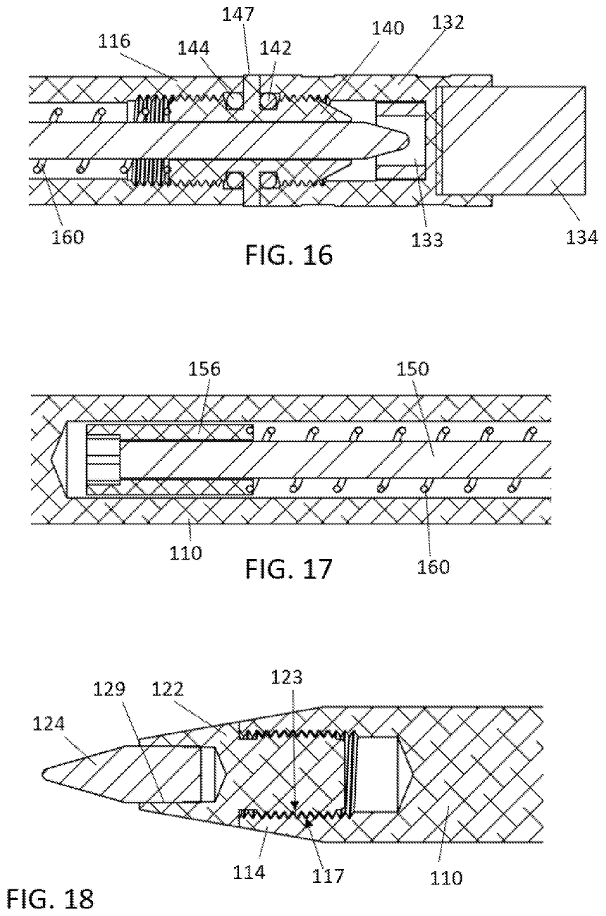

FIGS. 16-18 show enlarged cross sectional views of the writing end, a mid-portion and the pointed tool end of the multi-tool marking device 100, respectively. FIG. 16 shows the body writing end 116 having nib holder 140. The nib holder 140 has a first O-ring 142 disposed in a first groove adjacent one side of a flange 147 and a second O-ring 144 disposed in a second groove adjacent an opposite side of the flange 147 so the assembly seals the ink cartridge inside the nib holder 140, the removable cap 130, and the hexagonal body 110. The nib holder 140 includes male threads 141 and male threads 143 although in an alternate embodiment, the nib holder may be press fit in the body writing end 116 and the removable cap 130 may be press fit onto the nib holder 140. Shown in FIG. 17 are portions of the hexagonal body 110, spring 160, and ink cartridge 150, as well as bushing 156 which maintains the ink cartridge centered within the body 110. FIG. 18 shows the tool adapter 122 having male threads 123 engageable with female threads 117 on the hexagonal body 110 and a cavity 129 for securing a press fit, pointed and hardened tool 124. The pointed and hardened tool 124 is preferably tungsten carbide. The pointed and hardened tool 124 may alternately have male threads which engage with female threads in the cavity of the tool adapter 122.

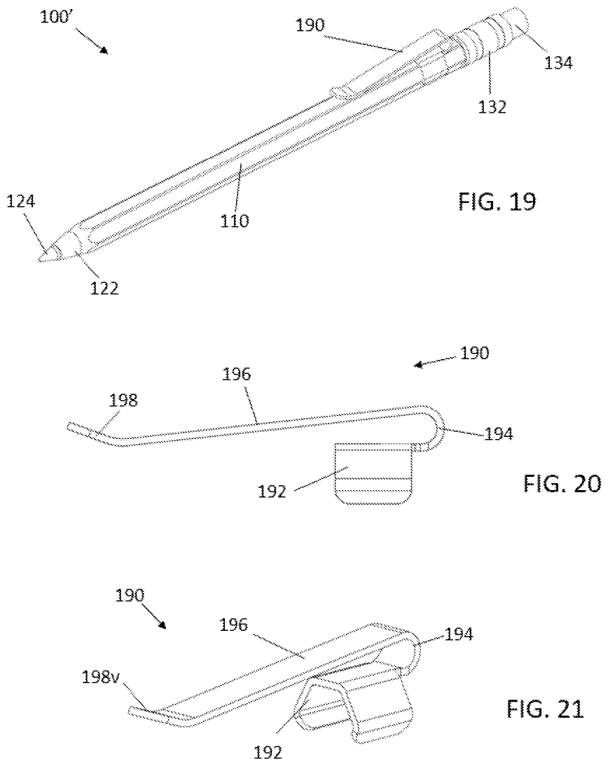

FIG. 19 shows a multi-tool marking device 100′ which includes a clip 190 attached for supporting the multi-tool marking device in a clothing pocket, carrying accessory or other item which includes material being sufficiently thin to allow attachment. The clip 190 as shown in FIGS. 20 and 21 includes an arcuate support 192 for engaging the hexagonal body 110, a bight 194 connecting the arcuate portion and an elongated flat member 196, and a bent portion 198 for easy attachment to the pocket or other material.

The multi-tool marking devices 100, 100′ are designed to appear substantially identical to a common wooden pencil. The design prevents the multi-tool marking device from appearing as a self-defense tool to an outside observer.

The metal components including the hexagonal body 110, nib holder 140, cap 132, and tool adapter 122 may be composed of aluminum, steel, titanium, brass, or alloy variations of these metals. The metal components may be painted or coated in a variety of colors using any of the available finishing processes, including but not limited to anodization and powder coating. The list of potential metals and alloys is not exhaustive, may be expanded, and may contain a mix of precious metals such silver, gold and platinum within the different components.

The multi-tool marking device may include, but is not limited to changes in the mechanical attachment of the two ends, utilizing a press fit on both ends, or utilizing a magnetic attachment of the pointed tools.

The metal components are currently produced through subtractive manufacturing, referring to machining, milling and/or turning operations. Additive manufacturing such as laser clad welding and/or laser sintering may be employed to create the individual components. The components may also be manufactured by casting.

An additional process to diamond-coat the hardened, sharp tip, further enhancing the hardness without incurring significantly higher material costs, may be added by a manufacturing process known as chemical vapor deposition (CVD), though not limited to that process.

The hardened tip may also be part of the implement body, manufactured as one piece by the methods described herein.

Text, logos and designs (identifying marks) may be added to the implement through printing, dot peen marking or laser etching. This is not an exhaustive list of the marking techniques available during the manufacturing process.

A clip consisting of a thin piece of stamped metal that is retained between the nib holder and the body may be added. This clip is similar to a pen cap clip and allows the user to attach this device to their pocket or any other relatively thin piece of material.

A protective cap to cover the hardened, sharp tip of the device, may be added, preventing unintentional use of any of its listed purposes. This cap may be made of leather, plastic polymer, carbon fiber, metal or any other commonly used engineering material.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claims. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A multi-tool marking device, comprising:
a hexagonal body having a tool end and a writing end;
a female threaded bore disposed on the tool end;
a first pointed tool engageable with the female threaded bore;
an elongated opening disposed on the writing end, the elongated opening having female threads disposed along an end portion of the elongated opening;
a nib holder having first male threads engageable with the elongated opening female threads, an adapter opening extending through the nib holder and second male threads opposite the first male threads;
a removable ink cartridge disposed in the elongated opening and through the nib holder, the removable ink cartridge having a writing tip disposed on one end and a second ink cartridge end opposite the writing tip;
a bushing engageable with the second ink cartridge end, the bushing disposable adjacent an internal end of the elongated opening, the bushing for centering the second ink cartridge end;
a spring disposable in the elongated opening between the bushing and the nib holder wherein the removable ink cartridge is disposed inside the spring for maintaining a position of the ink cartridge in the elongated opening;
a removable cap engageable with the second male threads on the nib holder, the removable cap for covering the ink cartridge;
a magnet disposed in the removable cap; and
an eraser attachable to the removable cap.

2. The multi-tool marking device of claim 1 wherein the first pointed tool includes a graphite tip and is engageable with the threaded bore.

3. The multi-tool marking device of claim 1 wherein the first pointed tool includes a tool adapter having male adapter threads engageable with the threaded bore a cavity for attachment of a tungsten carbide tip.

4. The multi-tool marking device of claim 3 wherein the tungsten carbide tip is a scribing tip.

5. The multi-tool marking device of claim 3 wherein the tungsten carbide tip is for breaking glass.

6. The multi-tool marking device of claim 1 wherein the first pointed tool includes a hard metal tip and is replaceable with a second pointed tool.

7. The multi-tool marking device of claim 6 wherein the hard metal tip is tungsten carbide.

8. The multi-tool marking device of claim 1 wherein the first pointed tool is replaceable with a second pointed tool.

9. The multi-tool marking device of claim 8 wherein the second pointed tool is a graphite writing tip.

10. The multi-tool marking device of claim 8 wherein the second pointed tool is for breaking glass.

11. The multi-tool marking device of claim 1, wherein the hexagonal body is made from a metal alloy selected from a group consisting of aluminum, steel, titanium, and brass.

12. The multi-tool marking device of claim 1, wherein the cap is secured to the hexagonal body by a threaded connection.

13. The multi-tool marking device of claim 1, wherein the magnet is secured to the cap by a press-fit connection.

14. The multi-tool marking device of claim 1, further comprising a flange disposed on the nib holder, a first O-ring disposed in a first groove adjacent one side of the flange and a second O-ring disposed in a second groove adjacent an opposite side of the flange.

15. The multi-tool marking device of claim 1, further comprising a clip for attaching the multi-tool marking device to a pocket or other thin piece of material.

16. The multi-tool marking device of claim 1, wherein the multi-tool marking device appears substantially identical to a common wooden pencil to make it discreet to an outside observer.

17. A multi-tool marking device, comprising:
a hexagonal body having a tool end and a writing end;
a threaded bore disposed on the tool end;
a first pointed tool engageable with the threaded bore;
an elongated opening disposed on the writing end, the elongated opening having female threads disposed along an end portion of the elongated opening;
a nib holder having first male threads engageable with the elongated opening female threads and an adapter opening extending through the nib holder;
a removable ink cartridge disposed in the elongated opening and through the nib holder, the removable ink cartridge having a writing tip disposed on one end and a second ink cartridge end opposite the writing tip; and
a removable cap engageable with the nib holder, the removable cap for covering the ink cartridge.

18. The multi-tool marking device of claim 17, including an eraser secured to the cap by an adhesive.

19. The multi-tool marking device of claim 17, further comprising a clip for attaching the device to a pocket or other thin piece of material.

20. The multi-tool marking device of claim 17, wherein the multi-tool marking device appears substantially identical to a common wooden pencil to make it discreet to an outside observer.
